(19) United States
(12) Patent Application Publication
(10) Pub. No.: US 2007/0179820 A1
(43) Pub. Date: Aug. 2, 2007

(54) Regional Benchmarking System

(76) Inventor: Robin Gaster, Silver Spring, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 11/307,239

(22) Filed: Jan. 27, 2006

(51) Int. Cl. G06F 9/44

(52) U.S. Cl. 705/7

(57) ABSTRACT

A database that generates summary as well as detailed comparisons between regions on a wide range of indicators, providing clear benchmarks to support the work of policymakers and analysts as well the general public. The first implementation of this data application system is the Regional Innovation Index, focused on economic innovation. The Regional Innovation Index allows a user to compare the performance of selected regions in terms of indicators such as capital availability, education, immigration patterns, labor availability, firms, industry composition, infrastructure and university activities. The system can also filter results by industry. Eventually it is anticipated that the Regional Innovation Index will be expanded to cover international comparisons. Additional Regional Indexes will address education, healthcare, the environment, and other sectors.

### FIELD OF THE INVENTION

The present invention is a method and process for summarizing and displaying statistical factors for various regions by using a color-coded indexing and data application system.

### BACKGROUND OF THE INVENTION

Policymakers and analysts, academic researchers and students, and the general public all need tools that will allow them to efficiently compare different geographical regions for research and analytical purposes. These comparisons facilitate the design of good public policy and also enable the tracking of policies as they are implemented.

For such comparisons to be possible, relevant information for each region must be compiled from a wide range of different sources through the collection of a large number of data sets (at least 200 data sets). This large aggregation of data should be organized for the user into a set of summary indicators. This system of summarized data—based on a compilation algorithm—would be presented to the user through a coherent, logical, color-coded system, wherein each color represents a rating for a specific indicator for a region in relation to other user-selected regions.

The system of aggregating and summarizing data would provide the user with immediate access to the “big idea,” which summarizes all the data contained in all the numerous data sets into a single easily understood presentation. The user could then focus in more detail on an individual indicator, and disaggregate it into sub-indicators. For example, an indicator covering the availability of workers in a region could be disaggregated into a number of sub-indicators, including the number of scientists, of engineers, of technicians, etc. These sub-indicators in turn could be disaggregated into groups of individual data sets—for example the number of life scientists employed within the region, or the number of engineers trained annually in the region. These individual data sets would be compared with similar data from other user-selected regions.

These multiple levels of comparison would be provided so as to offer users a range of different tools for accessing the information presented, including exporting to other applications and programs, charting, and spreadsheet format reports and downloads.

European publication 1376058A published by Dougherty et al. on Feb. 2, 2004, is a method of collecting market research information. This database differs in that it is intended for collecting market research information and advertising and is limited in scope in the kind of information it collects and provides. Unlike the present invention, the way of presenting the information is different in that it is not color-coded, and is not aggregated.

US Publication 2002/0138304 A1 published by Fontanesi on Sep. 26, 2002, is a method for cost-effective delivery of medical services pursuant to a procedure-based manual. It is unlike the present invention in that it does not collect a wide variety of information about different regions; nor is it color-coded.

US Publication 2003/0216943 A1 published by McPhee et al. on Nov. 20, 2003, is an interactive system and method for collecting and reporting health and fitness data. Unlike the present invention, it is limited in the type of information it collects and reports, and is intended specifically for health and fitness data, especially students in physical education programs. Nor does it employ an aggregation algorithm for creating color-coded summary level indicators.

US Publication 2004/0260573 A1 published by Schmitt on Dec. 23, 2004 is a method and system for utilization, assessment, development, and management of open-space land areas. Again, it is unlike the present invention in that the type of information it relates to is entirely different from the present invention, and it does not utilize a similar comparison method.

US Publication 2004/0267599 A1 published by Heires et al. on Dec. 30, 2004, is a process for calculating the economic value created by business activity. Unlike the present invention, the way of presenting the information is different and is not color-coded. It is also mainly limited to manufacturing costs and sales data for specific companies.

US Publication 2005/0171877 A1 published by Weiss on Aug. 4, 2005 is a method of making capital investment decisions concerning locations for business and/or facilities. Unlike the present invention it is intended as a method of consultation for businesses only and does not present comprehensive information about regions for policy-makers and analysts. Additionally, the way of presenting information is different in that it is not color-coded.

WIPO Publication 01/25957 A2 published by Barry on Apr. 12, 2001, is a personalized gaming and demographic collection method and apparatus. It is intended to collect demographic information about contestants on casino floors and is therefore entirely different from the present invention.

U.S. Pat. No. 4,872,113 issued to Dinerstein on Oct. 3, 1989, is a credit check scanner data analysis system. It is meant to interrelate scanner data from a supermarket checkout counter with demographic and economic data concerning individual customers to generate demographic and economic analysis of sales. It is therefore different from the present invention.

U.S. Pat. No. 5,524,187 issued to Feiner et al. on Jun. 4, 1996, is a nested display and interaction system and method. This invention is intended for the manipulation of scientific or engineering multivariate data for presenting it in a three-dimensional field; it is therefore entirely different from the present invention.

U.S. Pat. No. 6,047,234 issued to Cheverny et al. on Apr. 4, 2000 is a system and method for updating, enhancing, and refining a geographic database using feedback. It is related solely to the physical geography of a region, not the socio-economic factors.

U.S. Pat. No. 6,611,807 issued to Bernheim et al. on Aug. 26, 2003 is an economic security planning method and system. It is different from the present invention in that the purpose is to calculate a household's highest sustainable living standard and determine the savings and life insurance needed to ensure that living standard is maintained.

U.S. Pat. No. 6,628,314 issued to Hoyle on Sep. 30, 2003 is a computer interface method and apparatus with targeted advertising. It is unlike the present invention in that the software application includes targeted advertising based on demographics and user interaction with the computer. Similarly, U.S. Pa. No. 6,771,290 B1 issued to Hoyle on Aug. 3, 2004, is a computer interface method and apparatus with portable network organization system and targeted advertising. It is an extension and elaboration of the aforementioned patent.

Hence, there is a need for a data application that is easy to use but comprehensive, accurate and thorough in the range of information and data it can provide, and that also presents the information so that it is easily understood and easily subjected to further analysis. There is a need for a method and process that will increase the efficiency with which various regions, cities, and states can be compared and contrasted, thereby enabling policymakers, analysts, and researchers to be more productive. These needs can be addressed through a data application that uses color-coding to convey essential “big-picture” information to the user, while allowing the user to acquire details and exact statistics if that is required by the user. It does not suffice to simply use an Excel spreadsheet since the information needs to be presented in non-numerical format to be easily interpreted. Color-coding would be an effective method of presenting statistical information.

### SUMMARY OF THE INVENTION

The present invention generates comparisons between regions on a range of indicators. It is a system for comparing regional activity in a range of fields, including economic innovation, health care, education, and the environment. The system is designed to organize groups of data sets into sub-indicators, and to group sub-indicators into larger indicators. The entire set of larger indicators together constitutes a summary of the entire field of the query. The first implementation of the Regional Index focuses on economic innovation. Subsequent projects may include the Regional Education Index, the Regional Healthcare Index, and the Regional Environment Index.

Each Index allows users to compare regions in terms of all the factors identified in the academic and practitioner literatures as impacting economic innovation. For the Regional Innovation, these indicators might include education levels, immigration patterns, labor availability, capital availability, firm activities, industry composition, infrastructure deployment, and university capacity. The system will also filter results by industry.

In each, case, an Index will permit comparisons within the following kinds of regions in the United States:
states
metropolitan statistical areas
counties

Eventually it is anticipated that Indexes will be developed that provide international comparisons.

The Regional Innovation Index is the prototype for all the subsequent planned regional indexes. The present invention is based on a comprehensive and functional database that integrates approximately 200 data sets into the prototype Index. In principle, an unlimited number of data sets can be included in the system. In principle, additional filtering algorithms can also be introduced, to provide rankings based on industry classification, size of region, and other selected variables.

It is the object of the present invention to allow a user to access a large number of data sets within the framework of a comparison with other similar geographical regions, and to provide hierarchically organized summaries which present information at the specific level of detail required by the user, ranging from a single page summarizing all 200 data sets and comparisons, to the data contained in a single data set. The present invention is a way to present information in a color-coded manner so that it is intelligible, useful, easy to interpret and meaningful, as opposed to providing numbers which take more time to analyze and interpret. Therefore, it will not suffice to simply use an Excel spreadsheet since the information needs to be presented in non-numerical format to be easily interpreted. The only time the statistics in numbers are presented is at the lowest level of comparison. It also presents successive levels of data, and the further a user goes with the different categories of data there is a hierarchy of summaries.

### BRIEF DESCRIPTION OF THE DRAWINGS

FIG. 1 is the Summary Page of the Index.

FIG. 2 is the Comparison Region Page of the Index.

FIG. 3 is the Summary Page of the Index with the Home and Comparison Regions chosen for Summary Report.

FIG. 4 is the Inputs Summary Report for the chosen Regions.

FIG. 5 is the Inputs Summary Report of the data of one category for the chosen Regions.

FIG. 6 is the Outputs Summary Report for the chosen Regions.

FIG. 7 is the Outputs Summary Report of the data of one category for the chosen Regions.

FIG. 8 is a flowchart detailing the ranking development process.

### DETAILED DESCRIPTION OF THE PREFERRED EMBODIMENT

To use the present invention (Regional Innovation Index or “RII”), the user logs into the web site and onto the database with a username and password. As no personal data is stored on the system, other than usernames and passwords, the level of security currently required is limited. Multiple levels of access to the site are provided, and are currently used to determine who may see data but not change it (users), and who has full editing rights to the data (administrators).

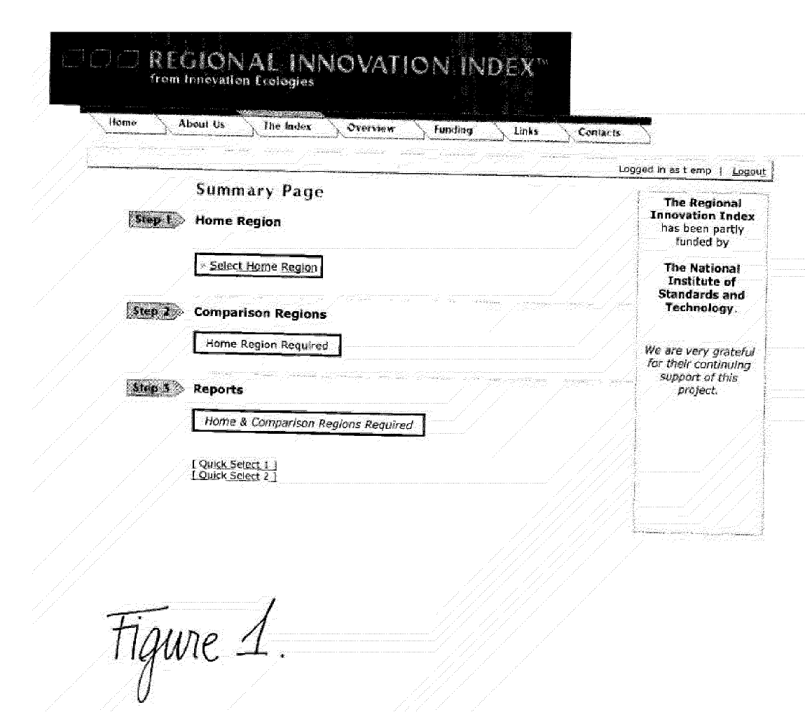

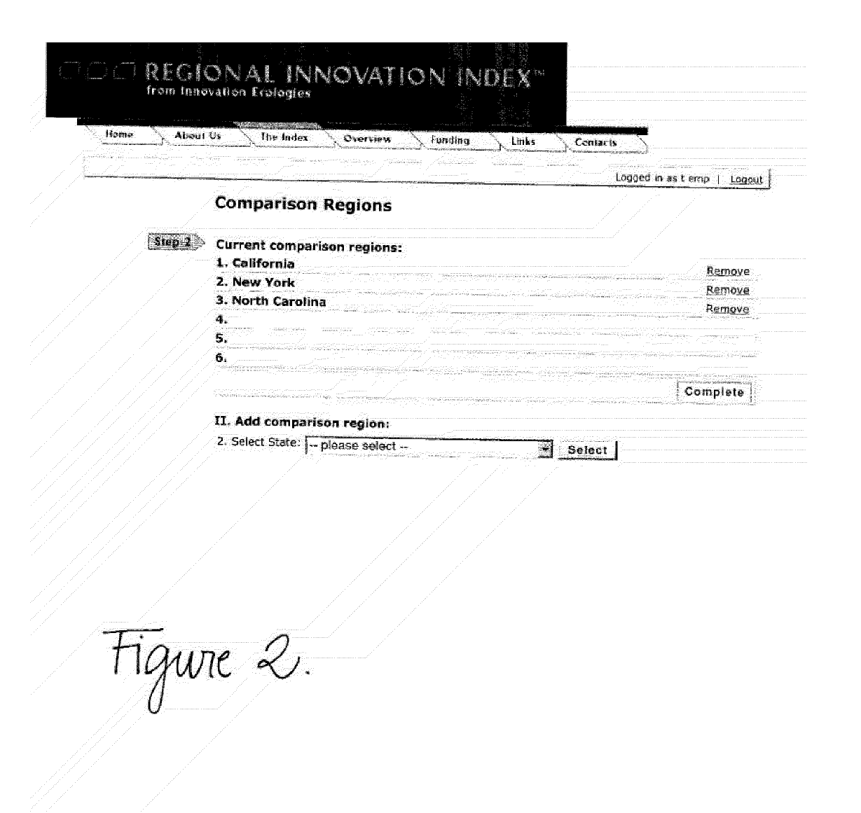

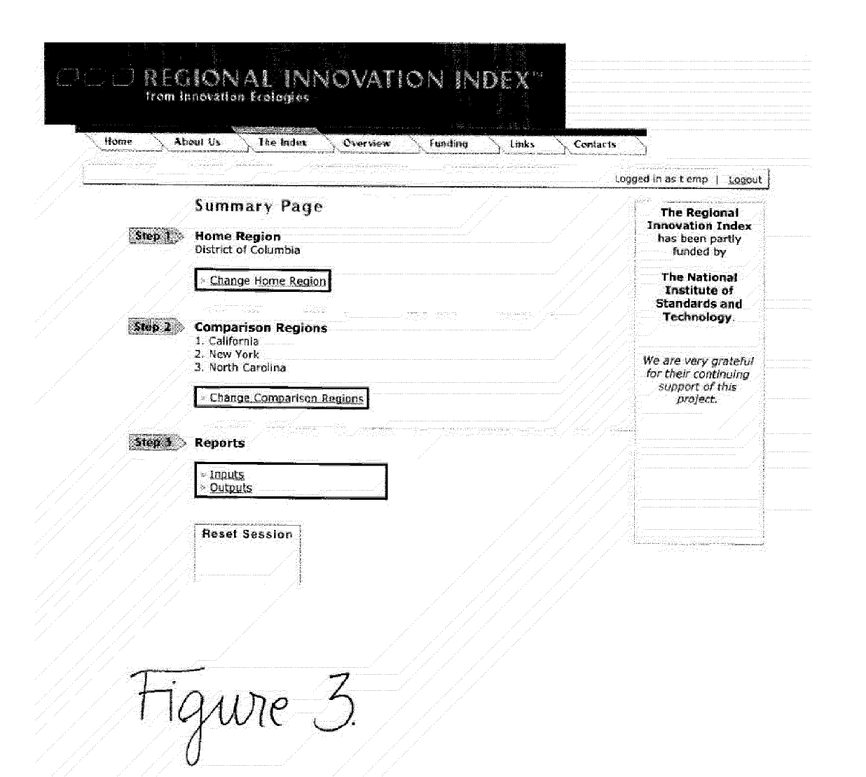

On accessing the system, users are presented with the Summary Page (see FIG. 1). Users then select a Home Region and Comparison Regions. FIG. 2 shows how a user can select up to six Comparison Regions; in this example they are selected by state. Once selection is complete, users return to the Summary Page. FIG. 3 shows the Summary Page with the Home and Comparison Regions chosen. As an example, the Home Region chosen is the District of Columbia and the Comparison Regions are California, New York and North Carolina.

It is anticipated that a user could select states, metropolitan statistical areas (MSAs), or counties for comparisons. In order to provide this capacity, data is maintained at the lowest possible level available (ZIP, then city, then county, then MSA, then state). The system automatically aggregates data to the level appropriate for the selected comparison. For example, if MSA's are selected for comparison, the system aggregates all zip code level data to county level, and then aggregates county level data to MSA level. It then proceeds to invoke the summarizing algorithms to generate relevant comparisons (see below).

Data are also included or excluded depending on the geographical level at which the user is operating. For example, some data are only available at the state level. These data would not be available if users selected sub-state regions for comparisons (e.g. counties).

Once the geography selection process is complete, users are presented with a range of reporting choices. These include:
Summary view, which provides a single page summary of all indicators
Input view, which define indicators recognized in the field as inputs into regional economic innovation
Output view, which define indicators recognized in the field as outputs from regional economic innovation
Regional Strengths view, which present only those indicators where the selected Home Region has scored above the median for the selected comparator regions
Regional Weaknesses view, which present only those indicators where the selected Home Region has scored below the median for the selected comparator regions
Industry Cluster view, which allows users to focus on specific industry clusters (e.g. life sciences)

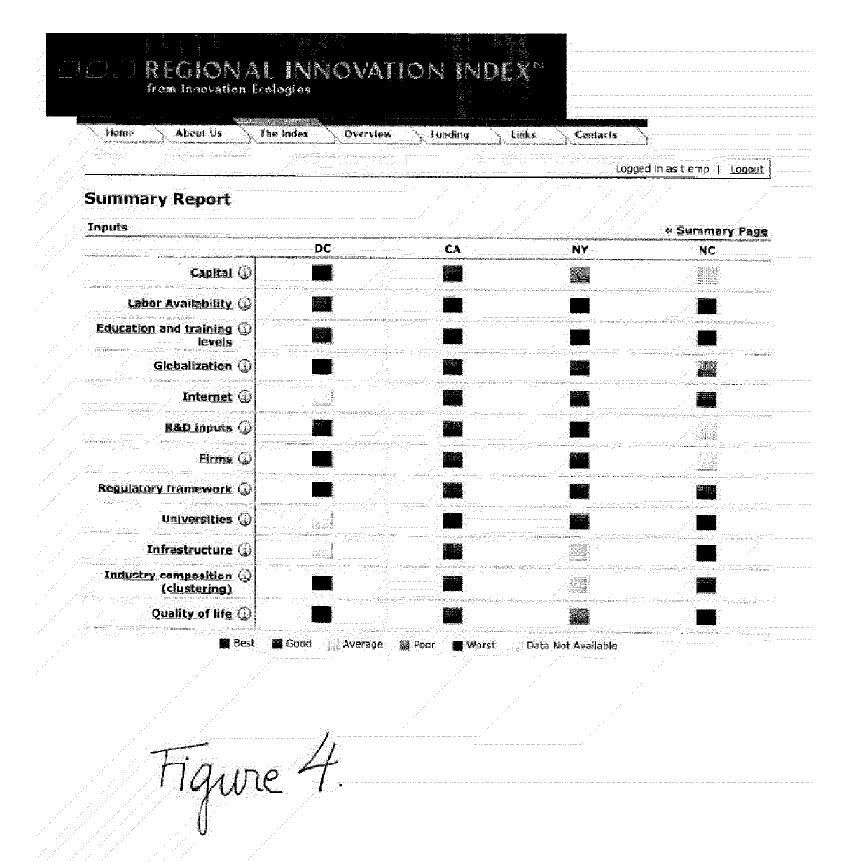

The user would then click on a specific View to present the kind of report they wanted to see. FIG. 4 shows the Input View for the chosen Regions. The various indicators are listed in the first column, including Capital, Education, Labor, Infrastructure and Quality of Life, among others. Each chosen Region (DC, CA, NY, NC in this example) has a box for each indicator. The boxes are color-coded so that the user can immediately and easily see the performance for the home region and each comparison region, relative to all the regions selected for comparison. The “best” region's box is color-coded in green; “good” is blue; “average” is yellow, “poor” is orange, “worst” is red, and “data not available” is white.

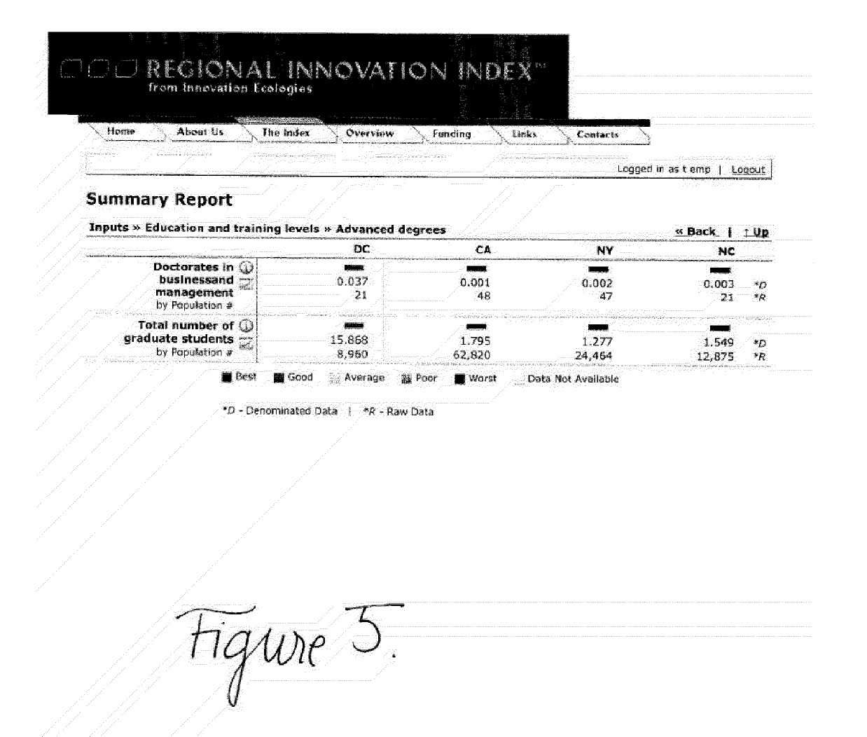

The user can then click on each of the indicators listed in the first column, such as Capital, Labor, or Education, to access the sub-indicator level for that comparator region. FIG. 5 shows the sub-indicator Input report for the Education & Training Levels indicator.

The sub-indicator report is similar to the indicator report, although it is based on different and more focused data. As at the indicator level, each chosen Region (DC, CA, NY, NC in this example) has a box for each sub-indicator. The boxes are color-coded so that the user can immediately and easily see the performance for the home region and each comparison region, relative to all the regions selected for comparison.

Users can then click on any of the sub-indicators listed in the left column to access the metric level, where individual data sets are displayed. For example, clicking on the “Advanced Degrees” sub-indicator within the Education & Training Levels indicator provides users with access to specific data sets—in this case, data such as “Doctorates in business and management” and “The total number of graduate students for each region.”

At this metric level, users are provided with three kinds of data:
Color-coded data similar to that available for indicators and sub-indicators, showing at a glance the relative rankings of the selected regions in terms of each individual data set
raw data, showing for example the total number of doctorates in business and management granted within the selected region during a specified time period
denominated data, which denominates the raw data against selected denominators—in the case of doctorates, per 1,000,000 population in the region. Denominated data provides in most cases a better framework of comparison.

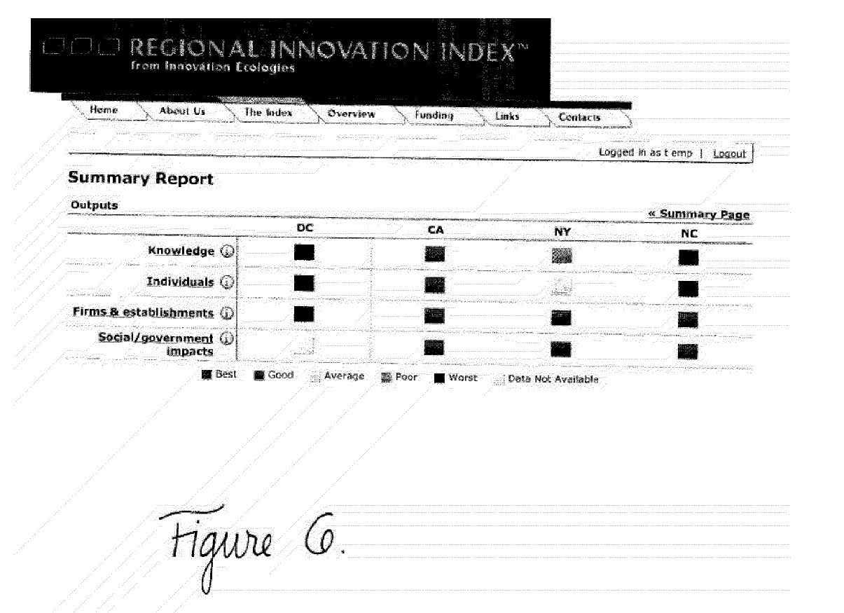

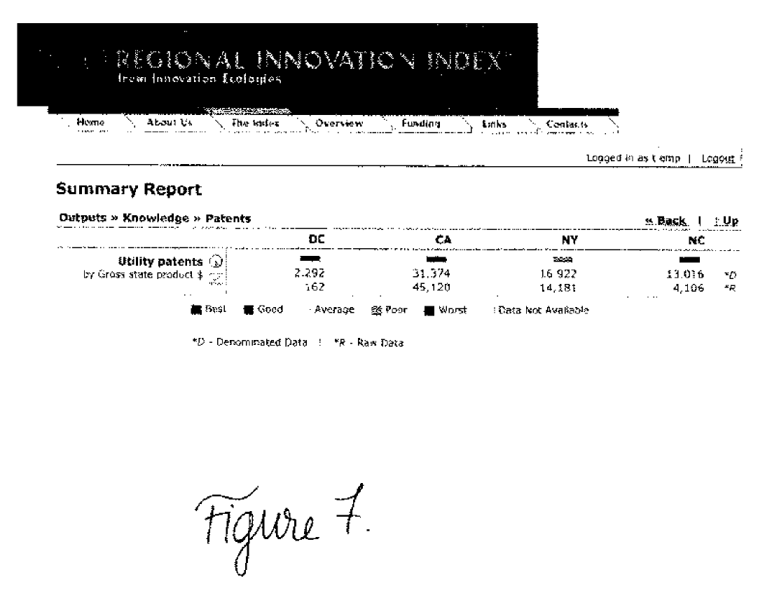

A similar methodology and data display approach is used for other views. FIG. 6 provides the Output View for the chosen Regions, containing four indicators: Knowledge, Individuals, Firms & Establishments, and Social/Governmental Impacts. In FIG. 7, an example is provided showing metrics for the “Outputs>Knowledge>Patents” sub-indicator. Clicking on this sub-indicator brings up the “Utility Patent” data set for each chosen Region along with the color-coded specification.

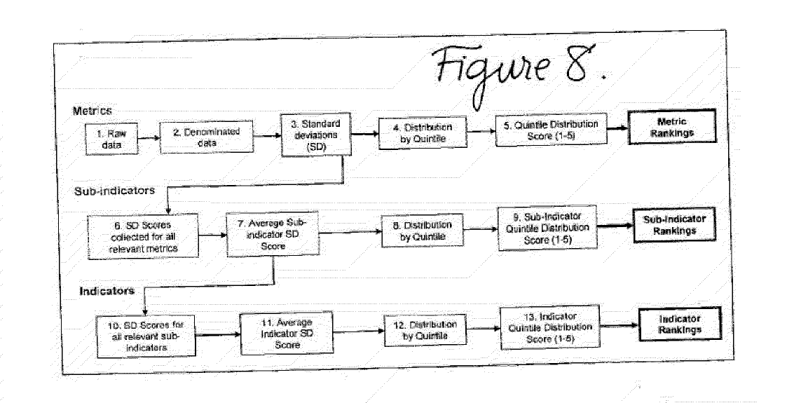

FIG. 8 is a flowchart showing how rankings and therefore color-codings are developed for individual metrics, sub-indicators, and indicators.

Each data set is processed and validated before upload into the database. The data are uploaded in standard CSV format. Raw data are converted into denominated data, using selected denominators such as population and gross national product, wherein the denominator selected depends on the specific data set involved. Standard deviations are developed for each data set, by measuring the magnitude of differences between the maximum and minimum data points for each data set. The standard deviation scores of each selected region are then distributed by quintile: the range between the highest and lowest standard deviations is calculated and divided by five. That product is subtracted from the top score to calculate the range for the 100^{th} to the 81^{st} percentile inclusive, and likewise for the other four percentile ranges. The product from the quintile distribution is assigned a number 1-5 based on the data; “1” is the lowest quintile while “5” is the highest quintile. These scores are used to create the metric (color-coded) rankings, which reflect the relative rankings of each region for the selected category. Using this system, it is possible to have one region score a “5” (highest) and all other regions to score a “1” (lowest). The objective of this approach is to offer users higher quality information than simply providing rankings, as the latter do not indicate in any way the gap between rankings.

The data are validated in three main ways: First, no adjustments are made to data provided by a third party. The third party (e.g. a Federal government agency) is responsible for the accuracy of the data it provides; errors remain the responsibility of the third party. Second, the system automatically crosschecks certain data by identifying outliers of the data range and checking location and industry code against the preexisting listings in the system. Third, there are multiple levels of staff review before the data are uploaded to the system.

The system provides users with four basic methods for extracting results from the system. They will be able to:
Use the print function to access a Print View for any reporting screen
Use a specially designed cut and paste module to copy any comparison table from the application to the clipboard of their computer, for pasting into other selected applications (e.g. a Microsoft Word document). The module adds significant metadata (e.g. data source information)
Generate a simple chart for export to other programs.
Where raw data are available, a user can also export the data into an Excel file.

It is anticipated that users will be able to save customized comparisons, identify a default Home Region, and use other types of personalization tools as well. Users will also be able to select comparator regions based on elective criteria (e.g. size, level of economic activity, other variables). Additional benchmarking possibilities, such as the inclusion of national and regional averages in the comparison process, are also feasible. Finally, users will be able to select and exclude individual data sets for comparison purposes, and will also be able to attach differential weighting to those data sets.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

What is claimed is:

1. A data application computer system, comprising:
comparator regions;
summarizing algorithms to present color-coded comparisons of data of said comparator regions;
indicator levels for each said comparator region;
sub-indicator levels for each said individual category;
metric levels showing individual data sets included of each said sub-indicator level;
filtering tools that allow users to limit the data used for reporting; and
a range of reporting choices for the data of said comparator regions.

2. The data application computer system of claim 1 wherein said data application system is configured to compare regions based on different criteria, including economic innovation, quality of life and standard of living, healthcare, education, or environment.

3. The data application system of claim 1 wherein said data application system is configured to aggregate data at the ZIP, city, county, metropolitan statistical area, and state level.

4. The data application computer system of claim 1 wherein said reporting choices of said data of said comparator regions comprise at least:
a single page summarizing all indicators;
an input view;
an output view;
a regional strengths view;
a regional weaknesses view; or
an industry cluster view.

5. The data application computer system of claim 1 wherein said data application system generates summary as well as detailed descriptions on a range of indicators for comparator regions.

6. The data application computer system of claim 1 wherein said data application system generates summary and detailed descriptions on a range of indicators using a color-coded system.

7. The data application computer system of claim 1 wherein said data application system is configured to present color-coded, raw, and denominated data.

8. The data application computer system of claim 1 wherein said data application system is configured to permit users to easily transfer reports and data to other computer applications.

9. A data application computer system, comprising:
First indicator levels corresponding to relationships amongst data in a first set;
Second indicator levels corresponding to relationships amongst data in a second set, said second set being a subset of data from said first set; and
Metric levels corresponding to relationships amongst data in a third set, said third set being a subset of data from said second set.
